(19) United States
(12) Patent Application Publication
(10) Pub. No.: US 2026/0261333 A1
(43) Pub. Date: Sep. 3, 2026

(54) STEP TRACKING METHOD FOR BEAM ALIGNMENT IN SATELLITE COMMUNICATIONS

(71) Applicant: YTTEK Technology Corp., Zhubei City (TW)

(72) Inventor: CHUNG-LIEN HO, Zhubei City (TW)

(21) Appl. No.: 19/390,858

(22) Filed: Nov. 17, 2025

Related U.S. Application Data
(60) Provisional application No. 63/765,473, filed on Feb. 28, 2025.

(51) Int. Cl. H04B 7/185; H04B 7/06

(52) U.S. Cl. CPC H04B 7/18519; H04B 7/0654; H04B 7/18513

(57) ABSTRACT

The present invention discloses a step tracking method for beam alignment in satellite communications. The method performs peak location detection of a two-dimensional beam pattern within a main beam region through iterative bivariate quadratic approximation. Each iteration includes: decoupling a bivariate joint function into two orthogonal one-dimensional quadratic functions; estimating quadratic approximation parameters of each function; calculating a target two-dimensional peak position based on the estimated parameters; setting the obtained peak position as an initial position for a subsequent iteration; and terminating detection when predefined stop conditions are satisfied. The method effectively avoids signal loss caused by large-angle scanning and achieves fast convergence, high accuracy, and strong robustness against noise.

This application claims the priority benefit of provisional patent application No. 63/765,473 titled “STEP TRACKING METHOD FOR BEAM ALIGNMENT IN SATELLITE COMMUNICATIONS” filed on 28 Feb. 2025, the disclosure of which is incorporated by reference herein in its entirety.

### BACKGROUND OF THE INVENTION

### Field of Invention

The present invention relates to the field of satellite communications, and more particularly to a step tracking method for beam alignment in satellite communication systems.

### Description of the Related Art

Satellite communications primarily involve the transmission signals through electromagnetic beams between ground-based user terminals (UTs) and target satellites in Earth orbit. The UTs include both fixed and mobile communication equipment. The mobile communication equipment includes, but is not limited to, devices installed on movable platforms such as ships and vehicles on the Earth's surface. Beam alignment between an antenna of the UT and a target satellite is essential to ensure the accuracy of link transmission.

The antenna utilizes the directivity of the beam to focus the transmitted signals toward the target satellite, thereby ensuring accurate link transmission. When relative motion occurs between the antenna and the target satellite, the antenna must track the target satellite and continuously direct the beam toward the moving satellite to maintain beam alignment.

Beam tracking is performed after the antenna establishes a link connection with the target satellite through an initial search process.

A step tracking method based on a received signal strength indicator (RSSI) can be applied to a two-dimensional (2D) beam pattern represented by a symmetric bivariate (2D) quadratic function, as shown in FIG. 1. The RSSI-based step tracking method addresses the technical challenge of performing peak location detection (PLD) of the beam pattern through an iterative step-by-step process within a main beam region.

### SUMMARY OF THE INVENTION

The main purpose of the present invention is to provide a step tracking method for beam alignment in satellite communications.

In order to achieve the aforementioned purpose, the present invention employs the following technical solution:

A step tracking method for beam alignment in satellite communications, wherein an antenna of a user terminal (UT) performs step beam tracking for satellite communications by executing peak location detection (PLD) of a two-dimensional (2D) beam pattern within a main beam region using an iterative bivariate (2D) quadratic approximation (curve fitting).

Each iteration of the method comprises the following steps:

Decoupling: Decoupling a bivariate (two-dimensional) joint function at a given initial position into two mutually orthogonal separate one-dimensional (1D) quadratic functions.

Estimation: Estimating quadratic approximation parameters for each of the two decoupled one-dimensional quadratic functions individually for the PLD.

Tracking: Calculating and obtaining a target two-dimensional peak position based on the above individually estimated parameters.

Setting Initial Position for Next Iteration: Setting the two-dimensional peak position obtained from the current iteration as an initial position for a subsequent iteration.

Stopping: Terminating the PLD process when the predefined stop conditions are satisfied.

Through a complete iterative process of decoupling, estimation, tracking, setting the initial position, and stopping, combined with a mathematical model of bivariate quadratic approximation, the present invention differs from the prior art, which relies solely on received signal strength indicator-based searching. Accordingly, the present invention not only enhances the accuracy and convergence speed of peak location detection, but also maintains stable estimation in noisy environments and prevents signal loss caused by large-angle scanning. Experimental embodiments demonstrate that the present invention can reduce tracking error to within 0.010, exhibiting advantages of fast convergence, high accuracy, noise resistance, and low signal loss, thereby providing performance significantly superior to that of the prior art.

### BRIEF DESCRIPTION OF THE DRAWINGS

FIG. 1 is a schematic diagram for a conventional RSSI-based step tracking method applied to a two-dimensional (2D) beam pattern.

FIG. 2 is a normalized 2D (joint) beam pattern for a 32-by-32 uniform planar array having a beamwidth of 3.16°.

FIG. 3 is a normalized one-dimensional (1D) (separated) beam pattern along an elevation angle direction according to the 2D (joint) beam pattern for a 32-by-32 uniform planar array.

FIG. 4 is a normalized 1D (separated) beam pattern along an azimuth angle direction according to the 2D (joint) beam pattern for a 32-by-32 uniform planar array.

FIG. 5 illustrates an example of a range of interest (ROI) for step tracking.

FIG. 6 illustrates a step tracking methodology and its properties.

FIG. 7 illustrates a design concept of 2D step tracking according to the present invention.

FIG. 8 is a block diagram of the 2D step tracking according to the present invention.

FIG. 9 illustrates the decoupling of a symmetric bivariate (2D) quadratic function.

FIG. 10 is a flowchart illustrating the 2D step tracking according to the present invention.

FIG. 11 illustrates a beam pattern approximation along an elevation angle direction.

FIG. 12 illustrates a beam pattern approximation along an azimuth angle direction.

FIG. 13 illustrates a tracking trajectory of the step tracking method according to the present invention along an elevation angle direction.

FIG. 14 illustrates a tracking trajectory of the step tracking method according to the present invention along an azimuth angle direction.

FIG. 15 illustrates a tracking error of the step tracking method according to the present invention.

FIG. 16 illustrates a 2D tracking trajectory of the step tracking method according to the present invention.

FIG. 17 illustrates a three-dimensional (3D) tracking trajectory of the step tracking method according to the present invention.

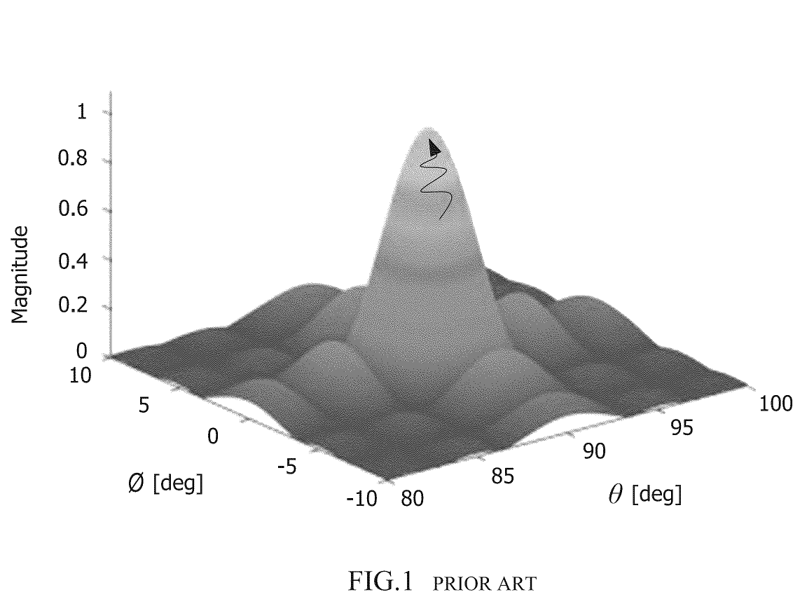

### DETAILED DESCRIPTION OF THE PREFERRED EMBODIMENTS

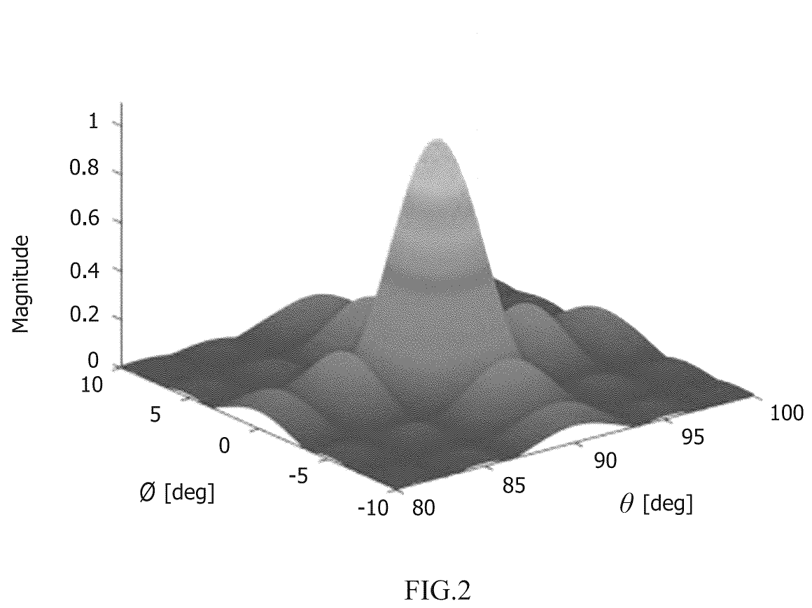

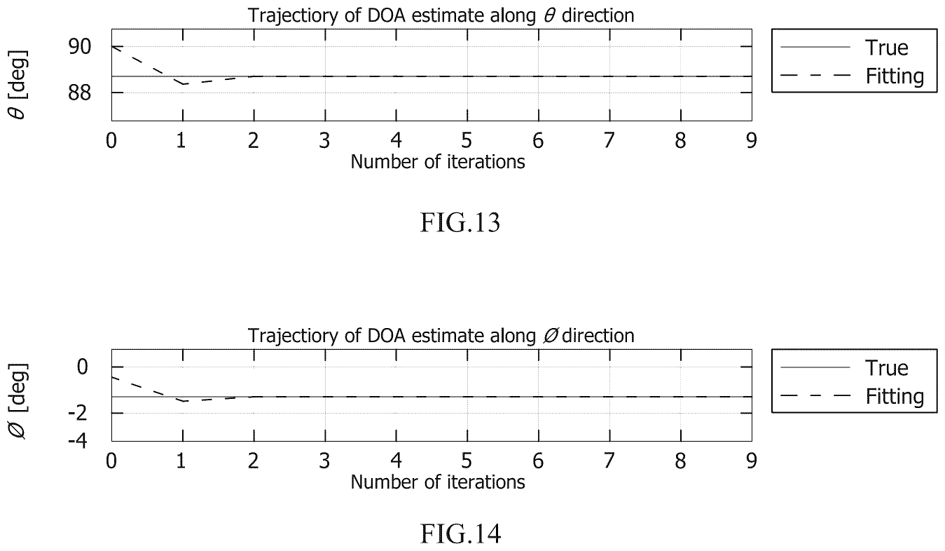

FIGS. 2 to 17 illustrate embodiments of a step tracking method of the present invention for beam alignment in satellite communications. These embodiments are provided for illustrative purposes only and should not be construed as limiting the scope of the invention.

The process of tracking a target satellite by an antenna of a user terminal (UT) includes a pure mechanical tracking method, a pure electrical tracking method, and a hybrid tracking method.

Pure Mechanical Tracking: The pure mechanical tracking method is performed using a fixed phase mechanical triple-axis shaft. For example, tracking angles (\hat{θ}ₒ, \hat{φ}ₒ)=(\hat{θ}ₘ, \hat{φ}ₘ)=(π/2, 0) can be obtained in a broadside direction of a horn antenna. This method is characterized by low accuracy, no signal loss during large-angle scanning, slow tracking speed, the presence of mechanical wear, and low cost.

Pure Electrical Tracking: The pure electrical tracking method is performed using dynamically adjustable electrical phase shifters to obtain tracking angles (\hat{θ}ₒ, \hat{φ}ₒ)=(\hat{θ}ₑ, \hat{φ}ₑ). This method is characterized by high accuracy, significant signal loss during large-angle scanning, fast tracking speed, no mechanical wear, and high cost.

Hybrid Tracking: The hybrid tracking method is performed by utilizing both the mechanical triple-axis shaft and the electrical phase shifter, thereby achieving a balance between the pure mechanical tracking and the pure electrical tracking.

The hybrid tracking is performed within a defined tracking range and includes both mechanical and electrical adjustments. In the initial stage, a one-step mechanical adjustment (for example, programmed tracking) is performed to achieve large-scale (coarse) tracking. Subsequently, a one-step electrical adjustment (for example, programmed tracking) or a multi-step electrical adjustment (for example, step tracking) is performed to achieve small-scale (fine) tracking.

The one-step mechanical adjustment and the one-step electrical adjustment are each a programmed tracking process executed based on geographical locations of the target satellite and the user terminal, as well as the attitude of the antenna body.

The multi-step electrical adjustment is performed by step tracking based on previous tracking results and according to a received signal strength indicator (RSSI). The step tracking method can be performed by at least one of the following methods: a direct search method, a gradient method, or a quadratic approximation method. The term “previous tracking results” refers to the tracking results obtained by the one-step mechanical adjustment prior to the multi-step electrical adjustment and does not include the results of the one-step electrical adjustment.

Example 1: FIG. 2 illustrates a normalized two-dimensional (2D) joint beam pattern for a 32-by-32 uniform planar array, where a 3-dB beamwidth is BW_{3 dB}=3.16°.

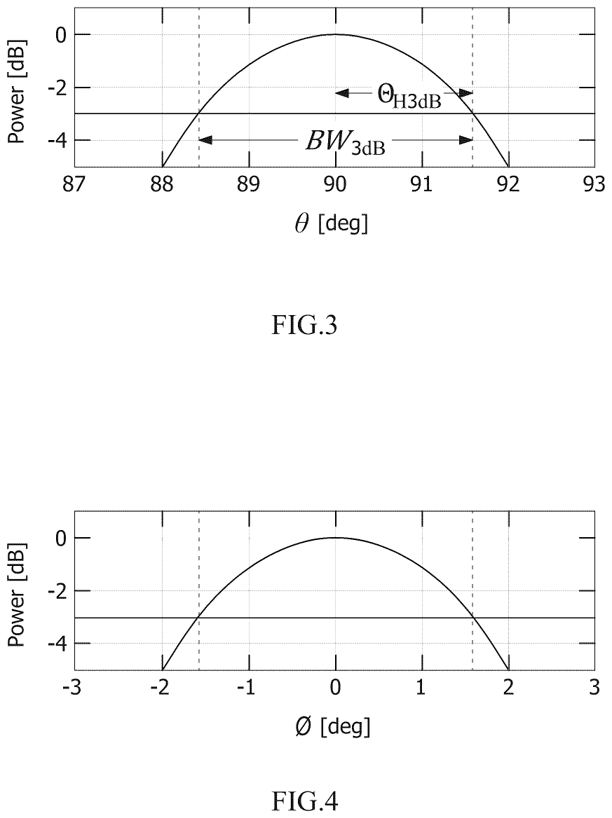

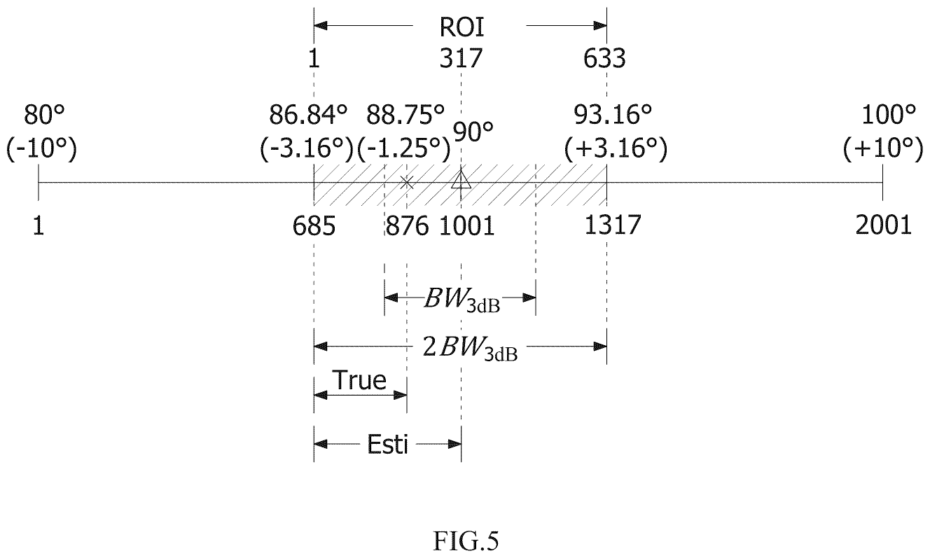

FIGS. 3 and 4 respectively illustrate normalized one-dimensional (1D) separated beam patterns along an elevation angle θ direction and an azimuth angle φ direction of the 2D joint beam pattern for the 32-by-32 uniform planar array. In these figures, θ_{H3 dB} represents the half-power angle from the beam center to the point dropping by 3-dB, and BW_{3 dB} represents the beamwidth at the 3-dB half-power point. FIG. 5 illustrates an example of a range of interest (ROI) for step tracking, in which ROI denotes the range of interest. The true sampling point index position is 876, the estimated sampling point index position is 1001, the term “true” represents the true peak position or the beam region based on the true peak, “Esti” represents the estimated peak position or the beam region based on the estimated peak, and 2BW_{3 dB} represents twice the beamwidth at the 3-dB half-power point.

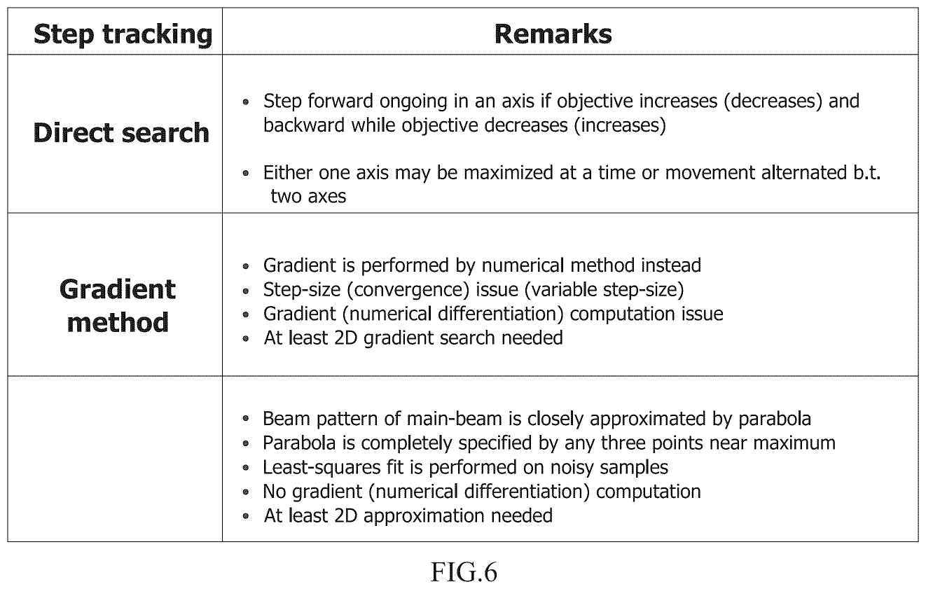

As shown in FIG. 6, the step tracking process (i.e., an extremum-seeking or hill-climbing scheme) is required to remain within the main beam region. This condition is both necessary and sufficient, and the performance improve within the 3-dB beamwidth range defined by the 3-dB half-power point. The step tracking is used only after the main beam acquisition process has been completed.

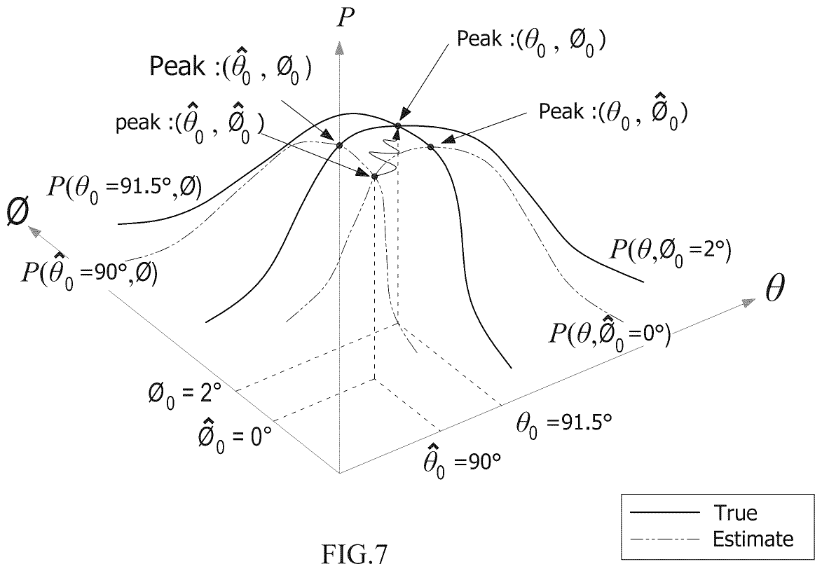

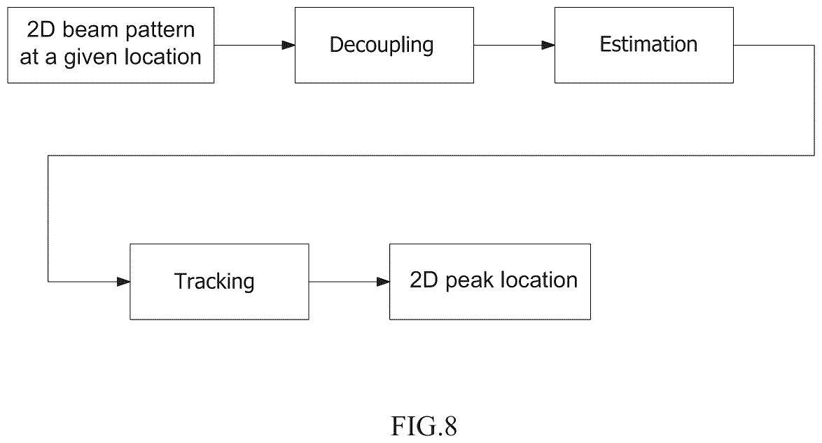

As shown in FIGS. 7 and 8, the procedure for performing peak location detection (PLD) of a beam pattern through a step-by-step process within the main beam region comprises the following steps:

Decoupling: Decoupling a bivariate joint function at a given input point into two orthogonal one-dimensional quadratic functions.

Estimation: Estimating the parameters for the quadratic approximation of each of the two decoupled one-dimensional quadratic functions individually.

Tracking: Obtaining a target two-dimensional peak position based on the above individually estimated parameters.

In FIG. 7, among multiple peak positions, an estimated peak position is represented as (\hat{θ}ₒ, \hat{φ}ₒ), and a true peak position is represented as (θₒ, φₒ).

The antenna of the UT performs step beam tracking for satellite communications by executing peak location detection (PLD) of a two-dimensional (2D) beam pattern within the main beam region using an iterative bivariate (2D) quadratic approximation (curve fitting). The processing performed during each iteration comprises the following steps:

Decoupling: Decoupling a bivariate two-dimensional (2D) joint function at a given initial position into two separate one-dimensional (1D) quadratic functions.

Estimation: Estimating the quadratic approximation parameters for each of the two decoupled one-dimensional (1D) quadratic functions individually for the peak location detection (PLD).

Tracking: Calculating and obtaining a target two-dimensional peak position based on the above individually estimated parameters.

Setting Initial Position for Next Iteration: Setting the two-dimensional peak position obtained from the current iteration as a given target position for a subsequent iteration.

Stopping: Terminating the peak location detection (PLD) process when the specified stop conditions are satisfied.

The stop conditions include:
(a) A norm of an error vector between a current estimate and a next estimate being lower than a predetermined threshold, and
(b) A difference in a beamforming (BF) output magnitude between the current and next estimates being lower than a predetermined threshold.

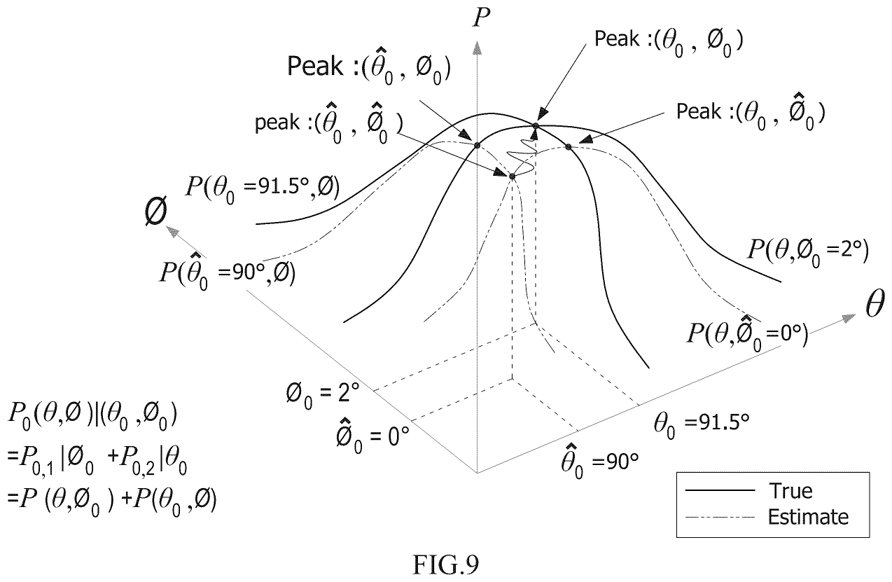

FIG. 9 illustrates a decoupled symmetric bivariate (2D) quadratic function, which consists of two orthogonally separated one-dimensional (1D) quadratic functions. The bivariate (2D) joint function at a specific (given) point is expressed as: Pₒ(θ, φ)|(θₒ, φₒ)=P_{o,1}|φₒ+P_{o,2}|θₒ=P(θ, φₒ)+P(θₒ, φ).

The decoupled one-dimensional quadratic functions are expressed as follows. A concave function (having a minimum value) indicates ã₁>0, whereas a convex function (having a maximum value) indicates ã₁<0:

### First One-Dimensional Quadratic Function:

$${P}_{o , 1} \vert {ϕ}_{o} ≡ P ( θ , {ϕ}_{o} ) = {a}_{1} {θ}^{2} + {b}_{1} {ϕ}_{o}^{2} + {c}_{1} θ {ϕ}_{o} + {d}_{1} θ + {e}_{1} {ϕ}_{o} + {f}_{1} = {\underbrace{{a}_{1}}}_{{\tilde{a}}_{1}} {θ}^{2} + {\underbrace{( {c}_{1} {ϕ}_{o} + {d}_{1} )}}_{{\tilde{b}}_{1}} θ + {\underbrace{( {b}_{1} {ϕ}_{o}^{2} + {e}_{1} {ϕ}_{o} + {f}_{1} )}}_{{\tilde{c}}_{1}} = {\tilde{a}}_{1} {θ}^{2} + {\tilde{b}}_{1} θ + {\tilde{c}}_{1} ( Standard form ) = {{\tilde{a}}_{1} ( θ - {θ}_{b , 1} )}^{2} + {P}_{b , 1} ( Vertex form )$$

$$where$$

$${θ}_{b , 1} = - \frac{{\tilde{b}}_{1}}{2 {\tilde{a}}_{1}} , {P}_{b , 1} = {\tilde{c}}_{1} - \frac{{\tilde{b}}_{1}^{2}}{4 {\tilde{a}}_{1}}$$

### Second One-Dimensional Quadratic Function:

$${P}_{o , 2} \vert {ϕ}_{o} ≡ P ( {θ}_{o} , ϕ ) = {a}_{2} {ϕ}^{2} + {b}_{2} {θ}_{o}^{2} + {c}_{2} {ϕθ}_{o} + {d}_{2} ϕ + {e}_{2} {θ}_{o} + {f}_{2} = {\underbrace{{a}_{2}}}_{{\tilde{a}}_{2}} {ϕ}^{2} + {\underbrace{( {c}_{2} {θ}_{o} + {d}_{2} )}}_{{\tilde{b}}_{2}} ϕ + {\underbrace{( {b}_{2} {ϕ}_{o}^{2} + {e}_{2} {θ}_{o} + {f}_{2} )}}_{{\tilde{c}}_{2}} = {\tilde{a}}_{2} {ϕ}^{2} + {\tilde{b}}_{2} ϕ + {\tilde{c}}_{2} ( Standard form ) = {{\tilde{a}}_{2} ( ϕ - {ϕ}_{b , 2} )}^{2} + {P}_{b , 2} ( Vertex form )$$

$$where$$

$${ϕ}_{b , 2} = - \frac{{\tilde{b}}_{2}}{2 {\tilde{a}}_{2}} , {P}_{b , 2} = {\tilde{c}}_{2} - \frac{{\tilde{b}}_{2}^{2}}{4 {\tilde{a}}_{2}}$$

It can be easily proven that \tilde{c}₁=\tilde{c}₂.

After the decoupling step, the estimation and tracking steps are performed. First, the bivariate quadratic function is estimated. Based on the parameters of the decoupled one-dimensional quadratic functions (ã₁, \tilde{b}₁, \tilde{c}₁) and (ã₂, \tilde{b}₂, \tilde{c}₂), a target two-dimensional location (θ=θ_{b,1}, φ=φ_{b,2}) corresponding to a beam peak is obtained. In a noise-free condition, these parameters (ã₁, \tilde{b}₁, \tilde{c}₁), i=1, 2 can be precisely estimated using any three points (a measurement combination) from each decoupled one-dimensional quadratic function, as follows:

$${\underbrace{[ \begin{matrix}{x}_{i , 1}^{2} & {x}_{i , 1} & 1 \\ {x}_{i , 2}^{2} & {x}_{i , 2} & 1 \\ {x}_{i , 3}^{2} & {x}_{i , 3} & 1\end{matrix} ]}}_{{A}_{i}} {\underbrace{[ \begin{matrix}{\hat{\tilde{a}}}_{i} \\ {\hat{\tilde{b}}}_{i} \\ {\hat{\tilde{c}}}_{i}\end{matrix} ]}}_{{\hat{ξ}}_{i}} = {\underbrace{[ \begin{matrix}{P}_{i , 1} \\ {P}_{i , 2} \\ {P}_{i , 3}\end{matrix} ]}}_{{p}_{i}} , i = 1 , 2$$

$$where$$

$${x}_{1 , j} = {θ}_{j} , {x}_{2 , j} = {ϕ}_{j} , {P}_{1 , j} = {P}_{o , 1 , j} , {P}_{2 , j} = {P}_{o , 2 , j} , j = 1 , 2 , 3.$$

The parameters are obtained \hat{ξ}ᵢ=Aᵢ⁻¹pᵢ, i=1, 2, ã₁θ²+\tilde{b}₁θ+\tilde{c}₁=P_{o,1},ã₂φ²+\tilde{b}₂φ+\tilde{c}₂=P_{o,2}, under the condition \tilde{c}₁=\tilde{c}₂.

In practice, during estimation of the two decoupled orthogonal quadratic functions (i=1, 2), the value of \tilde{ĉ}ᵢ tends to be overestimated due to double re-estimation.

### Curve Fitting (Standard Form):

$${P}_{o} ( θ , ϕ ) \vert ( {θ}_{o} , {ϕ}_{o} ) = {P}_{o , 1} \vert {ϕ}_{o} + {P}_{o , 2} ⌊ {θ}_{o} = P ( θ , {ϕ}_{o} ) + P ( {θ}_{o} , ϕ ) = ( {\hat{\tilde{a}}}_{1} {θ}^{2} + {\hat{\tilde{b}}}_{1} θ + \frac{{\hat{\tilde{c}}}_{1}}{2} ) + ( {\hat{\tilde{a}}}_{2} {ϕ}^{2} + {\hat{\tilde{b}}}_{2} ϕ + \frac{{\hat{\tilde{c}}}_{2}}{2} )$$

### Curve Fitting (Vertex Form):

$${P}_{o} ( θ , ϕ ) \vert ( {θ}_{o} , {ϕ}_{o} ) = {P}_{o , 1} \vert {ϕ}_{o} + {P}_{o , 2} ⌊ {θ}_{o} = P ( θ , {ϕ}_{o} ) + P ( {θ}_{o} , ϕ ) = {{\hat{\tilde{a}}}_{1} ( θ - {\hat{θ}}_{b , 1} )}^{2} + {{\hat{\tilde{a}}}_{2} ( ϕ - {\hat{ϕ}}_{b , 2} )}^{2} + {\hat{P}}_{b} , {\hat{P}}_{b} = {\hat{P}}_{b , 1} + {\hat{P}}_{b , 2}$$

$$where$$

$${\hat{θ}}_{b , 1} = - \frac{{\hat{\tilde{b}}}_{1}}{2 {\hat{\tilde{a}}}_{1}} , {\hat{ϕ}}_{b , 2} = - \frac{{\hat{\tilde{b}}}_{2}}{2 {\hat{\tilde{a}}}_{2}} ( Angular index of peak )$$

$${\hat{P}}_{b} = {\hat{P}}_{b , 1} + {\hat{P}}_{b , 2} = ( \frac{{\hat{\tilde{c}}}_{1}}{2} - \frac{{\hat{\tilde{b}}}_{1}^{2}}{4 {\hat{\tilde{a}}}_{1}} ) + ( \frac{{\hat{\tilde{c}}}_{2}}{2} - \frac{{\hat{\tilde{b}}}_{2}^{2}}{4 {\hat{\tilde{a}}}_{2}} ) ( Peak value )$$

In the beam tracking process, it is not necessary to reconstruct a complete beam shape (quadratic function), which c may be omitted; therefore, the accuracy of ci is not critical. Instead, only the peak magnitude and its corresponding angle (i.e., the peak position) are required.

When noise is present in the samples, iterative curve fitting can be performed using only three noisy samples per iteration. However, when the number of noisy samples exceeds three (J>>3), a one-time least-squared (LS) method can be applied for bivariate quadratic approximation:

$${\underbrace{[ \begin{matrix}{x}_{i , 1}^{2} & {x}_{i , 1} & 1 \\ ⋮ & ⋮ & ⋮ \\ {x}_{i , J}^{2} & {x}_{i , J} & 1\end{matrix} ]}}_{{A}_{i}} {\underbrace{[ \begin{matrix}{\hat{\tilde{a}}}_{i} \\ {\hat{\tilde{b}}}_{i} \\ {\hat{\tilde{c}}}_{i}\end{matrix} ]}}_{{\hat{ξ}}_{i}} = {\underbrace{[ \begin{matrix}{P}_{i , 1} \\ ⋮ \\ {P}_{i , J}\end{matrix} ]}}_{{p}_{i}} , i = 1 , 2 , J >> 3$$

$$where$$

$${x}_{1 , j} = {θ}_{j} , {x}_{2 , j} = {ϕ}_{j}$$

$${P}_{1 , j} = {P}_{o , 1 , j} , {P}_{2 , j} = {P}_{o , 2 , j} , j = 1 , … , J$$

The parameters are calculated as \hat{ξ}ᵢ=Aᵢ⁻¹pᵢ, i=1, 2

The algorithm of the k^{th} iteration of the iterative curve fitting method comprises the following sequential steps:
Step 1: Provide an estimate of a target location \hat{x}ₖ=(\hat{x}_{1,k}, \hat{x}_{2,k}) and measure a beamforming (BF) output magnitude P(\hat{x}_{1,k}, \hat{x}_{2,k}), where the initial estimate of the target location (\hat{x}_{1,k}, \hat{x}_{2,k}) can be predetermined using methods such as programmed tracking;
Step 2: Select two locations \hat{x}_{i,j,k}, where i=1, 2, j=1, 2, around \hat{x}ₖ to construct a three-point measurement set [symbol] , i=1, 2, and measure the corresponding beamforming (BF) output magnitudes [symbol] , i=1, 2 along two orthogonal axes.

For the first axis:

$${𝒮}_{1 , k} = \{ {\hat{x}}_{1 , 1 , k} = ( {x}_{1 , 1 , k} , {\hat{x}}_{2 , k} ) , {\hat{x}}_{k} = ( {\hat{x}}_{1 , k} , {\hat{x}}_{2 , k} ) , {\hat{x}}_{1 , 2 , k} = ( {x}_{1 , 2 , k} , {\hat{x}}_{2 , k} ) \}$$

$${P}_{{𝒮}_{1 , k}} = \{ P ( {\hat{x}}_{1 , 1 , k} ) , P ( {\hat{x}}_{k} ) , P ( {\hat{x}}_{1 , 2 , k} ) \}$$

For the second axis:

$${𝒮}_{2 , k} = \{ {\hat{x}}_{2 , 1 , k} = ( {\hat{x}}_{1 , k} , {x}_{2 , 1 , k} ) , {\hat{x}}_{k} = ( {\hat{x}}_{1 , k} , {\hat{x}}_{2 , k} ) , {\hat{x}}_{2 , 2 , k} = ( {\hat{x}}_{1 , k} , {x}_{2 , 2 , k} ) \}$$

$${P}_{{𝒮}_{2 , k}} = \{ P ( {\hat{x}}_{2 , 1 , k} ) , P ( {\hat{x}}_{k} ) , P ( {\hat{x}}_{2 , 2 , k} ) \}$$

Step 3: Estimate a quadratic function parameter vector \hat{ξ}_{i,k}=[\tilde{â}_{i,k}, \tilde{\hat{b}}_{i,k}, \tilde{ĉ}_{i,k}]^{T}, i=1, 2, for each of the two orthogonal axes (i=1, 2) using the measurement sets S_{i,k} and the corresponding beamforming (BF) output magnitudes P_{S}_{_{i,k}}, where

[symbol]

Step 4: Update a target location \hat{x}ₖ based on the estimated parameters of the quadratic function, and measure the beamforming (BF) output magnitudes, wherein

[symbol]

and

[symbol]

Step 5: Check whether the convergence conditions are satisfied:

[symbol]

If any of these conditions are satisfied, output \hat{x}ₖ₊₁ and terminate the algorithm. Otherwise, update the iteration k=k+1 by setting

[symbol]

and return to Step 2 to repeat the process.

Compared with a gradient search method, the iterative curve fitting algorithm of the present invention does not require gradient computations and is therefore more robust, being free from step-size sensitivity. In addition, the iterative curve fitting algorithm provides very fast convergence and high accuracy, with only slightly higher computational complexity involving a third-order inverse operation.

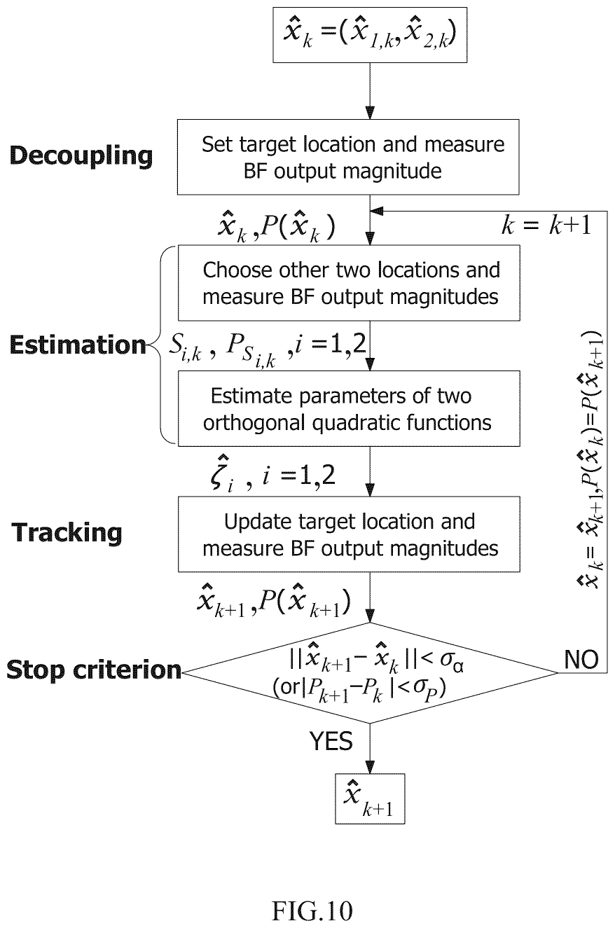

The overall process flow of the k^{th} iteration of the two-dimensional (2D) iterative curve fitting method is illustrated in FIG. 10.

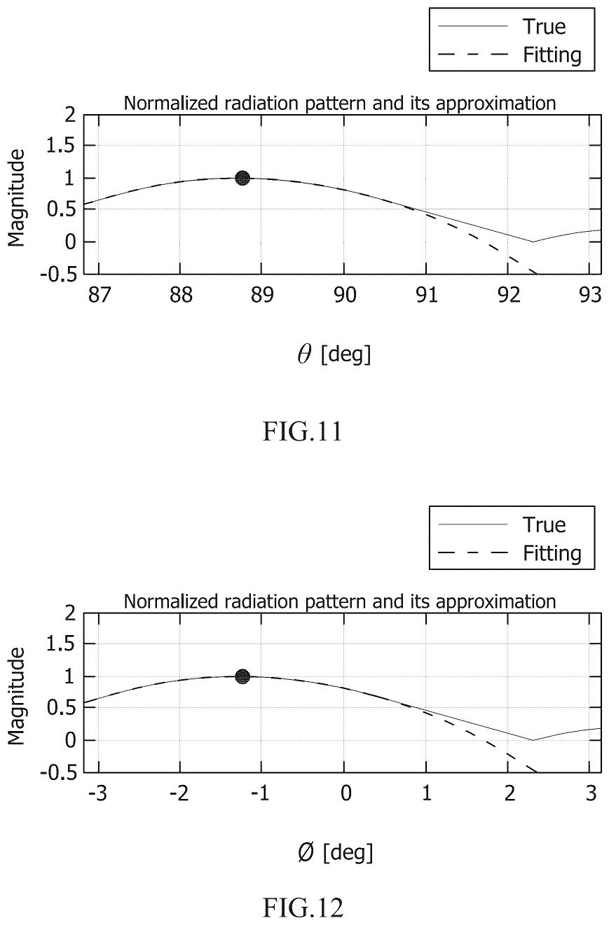

As shown in FIGS. 11 to 15, Example 2 demonstrates the tracking performance of the present invention, including beam pattern approximation, tracking trajectory, and tracking error, under the following parameters:
N_{y}=N_{z}=32 (gain G_{B}=30.1 [dB] and 3-dB half-power point beamwidth BW_{3 dB}=3.16°);
Initial beam peak offsets: (e_{θ}=1.25°, e_{φ}=1.25°);
Initial and final target angular positions: (\hat{θ}_{o,0}=90°, \hat{φ}_{o,0}=0°), (θₒ=88.75°, φₒ=−1.25°);
Signal-to-noise ratio (SNR): 10 (equivalent to 10 dB).

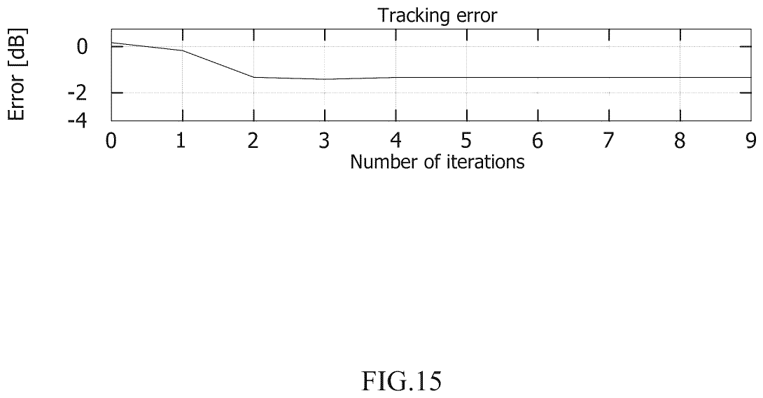

According to FIG. 15, the tracking error is ∥e(θ, φ)∥=0.0079°.

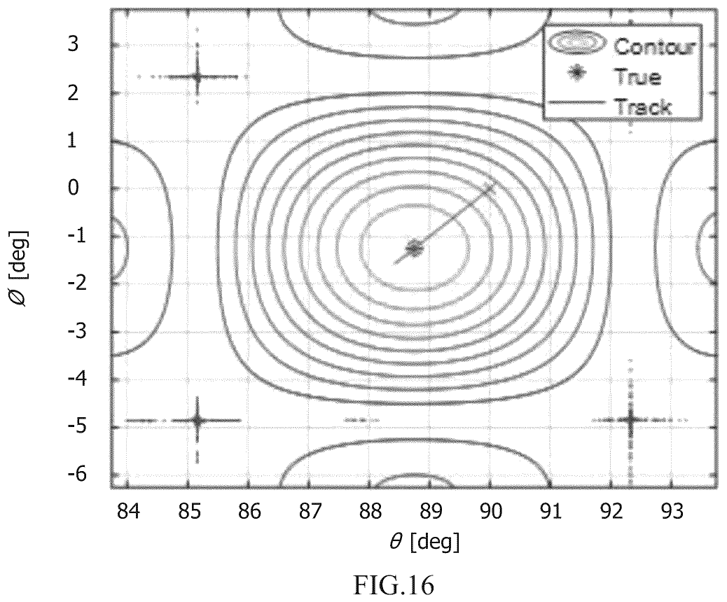

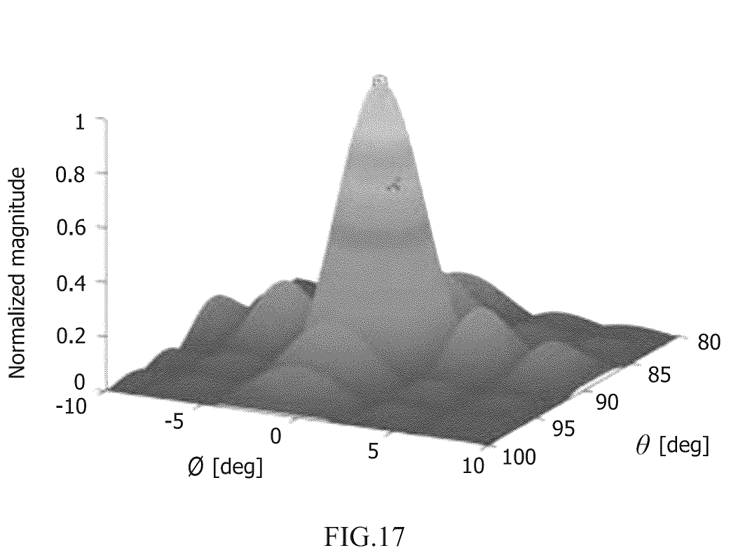

FIG. 16 illustrates a two-dimensional (2D) tracking trajectory of Example 2, corresponding to the convergence process of the iterative curve fitting in Example 2. FIG. 17 illustrates a three-dimensional (3D) tracking trajectory of Example 2. FIG. 17 serves as a three-dimensional visualization supplement to FIG. 16, representing a normalized beam magnitude distribution in which the tracking curve gradually converges to a main-lobe peak position.

The present invention, through a complete iterative process comprising decoupling, estimation, tracking, setting the initial position, and applying stop conditions, in combination with a mathematical model of bivariate quadratic approximation, fundamentally differs from prior art methods that rely solely on received signal strength indicator (RSSI)-based searching. Accordingly, the present invention not only improves the accuracy and convergence speed of peak location detection but also maintains stable estimation performance in noisy environments and prevents signal loss caused by large-angle scanning. Experimental embodiments demonstrate that the present invention can reduce tracking error to within 0.01°, providing advantages of high-speed convergence, high accuracy, noise resistance, and low signal loss, thereby achieving performance significantly superior to that of the prior art.

What is claimed is:

1. A step tracking method for beam alignment in satellite communications,
wherein an antenna of a user terminal performs peak location detection on a two-dimensional beam pattern within a main beam region and executes the peak location detection using iterative bivariate (two-dimensional) quadratic approximation (curve fitting), thereby realizing step beam tracking for satellite communications;
wherein, in each iteration, the step beam tracking method comprises:
decoupling: at a given initial position, decoupling a bivariate (two-dimensional) joint function into two mutually orthogonal one-dimensional quadratic functions;
estimation: for each of the one-dimensional quadratic functions, respectively estimating quadratic approximation parameters thereof;
tracking: based on the respectively estimated quadratic approximation parameters, calculating and obtaining a target two-dimensional peak position;
setting an initial position for a next iteration: setting the two-dimensional peak position obtained in a current iteration as an initial position for a subsequent iteration; and
stopping: terminating the peak location detection when predefined stop conditions are satisfied.

2. The step tracking method for beam alignment in satellite communications according to claim 1,
wherein the stop conditions include:
a norm of an error vector between a current estimate and a next estimate being lower than a predetermined threshold; and
a difference in beamforming output magnitude between the current estimate and the next estimate being lower than a predetermined threshold.

3. The step tracking method for beam alignment in satellite communications according to claim 1,
wherein the method is executed in a multi-step electrical adjustment of hybrid tracking to achieve small-scale tracking.

4. The step tracking method for beam alignment in satellite communications according to claim 3,
wherein the step tracking of the multi-step electrical adjustment is performed based on a received signal strength indicator.

5. The step tracking method for beam alignment in satellite communications according to claim 1,
wherein, when noise is present in samples, iterative curve fitting is adopted, and in each iteration, only three noisy samples are used for parameter estimation.

6. The step tracking method for beam alignment in satellite communications according to claim 1,
wherein, when a number of noisy samples is greater than three, a one-time least-squared method is applied for two-dimensional quadratic approximation to obtain parameter estimation;
wherein, when noise is present in the samples, curve fitting is performed in each iteration using only three noisy samples, and when a number of the noisy samples exceeds three (J>>3), the one-time least-squared (LS) method is applied for the bivariate quadratic approximation.

7. The step tracking method for beam alignment in satellite communications according to claim 1,
wherein an iterative curve fitting algorithm of a k-th iteration comprises the following sequential steps:
step one: providing an estimated value of a target position and measuring a beamforming output magnitude at the target position;
step two: around the target position, along two mutually orthogonal axes, respectively selecting one position to form a three-point measurement set, and respectively measuring beamforming output magnitudes of the target position and of the selected positions;
step three: for each of the orthogonal axes, using the three-point measurement set and corresponding beamforming output magnitudes thereof, respectively estimating a quadratic function parameter vector;
step four: updating the target position according to the estimated quadratic function parameter vector to obtain an updated position, and measuring a beamforming output magnitude of the updated position; and
step five: checking whether an absolute value of a difference between the target position and the updated position, or an absolute value of a difference between the beamforming output magnitude of the target position and the beamforming output magnitude of the updated position, satisfies convergence conditions;
if any of the convergence conditions is satisfied, outputting the updated position and terminating the algorithm; otherwise, performing an update iteration by using the updated position as the target position, using the beamforming output magnitude of the updated position as the beamforming output magnitude of the target position, returning to step two, and repeating steps two to five.

8. The step tracking method for beam alignment in satellite communications according to claim 7,
wherein the convergence conditions are set such that a norm of a tracking position error is less than 0.01°;
wherein the tracking position error is defined as a norm of an angle-difference vector between an estimated peak position and a true peak position.

9. The step tracking method for beam alignment in satellite communications according to claim 1,
wherein the antenna of the user terminal is a 32×32 uniform planar array, with a beamwidth defined by a 3-dB half-power point being 3.16°.
